(19) United States
(12) Patent Application Publication
(10) Pub. No.: US 2017/0092988 A1
(43) Pub. Date: Mar. 30, 2017

(54) METHOD OF MANUFACTURING ELECTRODE LAMINATE AND METHOD OF MANUFACTURING ALL-SOLID-STATE BATTERY

(71) Applicant: Toyota Jidosha Kabushiki Kaisha, Toyota-shi (JP)

(72) Inventors: Kengo Haga, Susono-shi (JP); Junichiro Nishino, Gotenba-shi (JP); Norihiro Ose, Shizuoka-ken (JP); Hajime Hasegawa, Susono-shi (JP); Mitsutoshi Otaki, Susono-shi (JP); Hiroki Kubo, Susono-shi (JP); Keisuke Omori, Kariya-shi (JP)

(21) Appl. No.: 15/274,275

(22) Filed: Sep. 23, 2016

(30) Foreign Application Priority Data
Sep. 24, 2015 (JP) 2015-187475

(51) Int. Cl. H01M 10/0585; H01M 4/04

(52) U.S. Cl. CPC H01M 10/0585; H01M 4/0404; H01M 4/0407

(57) ABSTRACT

A method of manufacturing an electrode laminate, which includes an active material layer and a solid electrolyte layer formed on the active material layer, includes: an active material layer forming step of forming an active material layer; and a solid electrolyte layer forming step of forming a solid electrolyte layer on the active material layer by applying a solid electrolyte layer-forming slurry to the active material layer and drying the solid electrolyte layer-forming slurry. In this method, a product of a filling factor of the active material layer and a volume proportion of an active material in the active material layer is 0.33 to 0.41.

### CROSS REFERENCE TO RELATED APPLICATIONS

This application claims priority Japanese Patent Application No. 2015-187475 filed on Sep. 24, 2015, which is incorporated herein by reference in its entirety including the specification, drawings and abstract.

### BACKGROUND

1. Technical Field

The present disclosure relates to a method of manufacturing an electrode laminate for an all-solid-state battery, the electrode laminate including an active material layer and a solid electrolyte layer that is provided on the active material layer. The disclosure also relates to a method of manufacturing an all-solid-state battery.

2. Description of Related Art

Recently, an all-solid-state battery in which an electrolytic solution is replaced with a solid electrolyte has attracted attention. In contrast to secondary batteries in which an electrolytic solution is used, an electrolytic solution is not used in an all-solid-state battery. Therefore, for example, the decomposition of an electrolytic solution caused by overcharging does not occur, and cycle durability and energy density are high.

For example, an all-solid-state battery has a structure in which a positive electrode current collector layer, a positive electrode active material layer, a solid electrolyte layer, a negative electrode active material layer, and a negative electrode current collector layer are laminated in this order. In order to improve the energy density and performance of the all-solid-state battery having the above structure, in general, it is preferable that the amount of an active material in the all-solid-state battery is large and that the thickness of the solid electrolyte layer is as thin as possible. In particular, in a case where the thickness of the solid electrolyte layer can be made small, more active material can be incorporated into the all-solid-state battery in an amount corresponding to the reduced thickness of the solid electrolyte layer. As a result, the energy density can be improved, and the internal resistance of the battery can be reduced.

However, in a case where the thickness of the solid electrolyte layer is small, a portion of the solid electrolyte layer may be damaged due to, for example, manufacturing conditions of the solid electrolyte layer, and thus short-circuiting is more likely to occur in the all-solid-state battery. Accordingly, a method of manufacturing an all-solid-state battery capable of preventing short-circuiting while reducing the thickness of a solid electrolyte layer has been studied.

A method of manufacturing an all-solid-state battery disclosed in Japanese Patent Application Publication No. 2015-008073 (JP 2015-008073 A) includes a step of applying a solid electrolyte layer-forming slurry to an active material layer to form a solid electrolyte layer thereon. JP 2015-008073 A describes that the active material layer may be pressed before applying the solid electrolyte layer-forming slurry thereto.

### SUMMARY

In regard to this point, the present inventors discovered the following points: in a case where a portion of the solid electrolyte layer-forming slurry is likely to seep in the vicinity of the surface of the active material layer on which the solid electrolyte layer is not formed, the thickness of the solid electrolyte layer varies, that is, thin and thick portions are formed in the solid electrolyte layer; and in a case where a portion of the solid electrolyte layer-forming slurry is not likely to seep in the vicinity of the surface of the active material layer on which the solid electrolyte layer is not formed, the interface resistance between the solid electrolyte layer and the active material layer increases.

The present disclosure provides a method of manufacturing an electrode laminate and a method of manufacturing an all-solid-state battery, with which short-circuiting can be prevented while reducing the thickness of a solid electrolyte layer and with which the internal resistance of a battery can be reduced.

According to a first aspect of the disclosure, there is provided a method of manufacturing an electrode laminate which includes an active material layer and a solid electrolyte layer formed on the active material layer. This method includes: forming the active material layer; and forming the solid electrolyte layer on the active material layer by applying a solid electrolyte layer-forming slurry to the active material layer and drying the solid electrolyte layer-forming slurry, in which a product of a filling factor of the active material layer and a volume proportion of an active material in the active material layer is 0.33 to 0.41.

The active material layer may be pressed.

According to a second aspect of the disclosure, there is provided a method of manufacturing an all-solid-state battery which includes a positive electrode current collector layer, a positive electrode active material layer, a solid electrolyte layer, a negative electrode active material layer, and a negative electrode current collector layer in this order. This method includes: forming the positive electrode active material layer and the negative electrode active material layer on the positive electrode current collector layer and the negative electrode current collector layer, respectively; forming the solid electrolyte layer on at least one of the positive electrode active material layer or the negative electrode active material layer by applying a solid electrolyte layer-forming slurry to the at least one of the positive electrode active material layer or the negative electrode active material layer and drying the solid electrolyte layer-forming slurry; and laminating the positive electrode current collector layer, the positive electrode active material layer, the solid electrolyte layer, the negative electrode active material layer, and the negative electrode current collector layer in this order and joining the positive electrode current collector layer, the positive electrode active material layer, the solid electrolyte layer, the negative electrode active material layer, and the negative electrode current collector layer to each other such that the solid electrolyte layer is interposed between the positive electrode active material layer and the negative electrode active material layer, in which a product of a filling factor of the active material layer and a volume proportion of an active material in the active material layer is 0.33 to 0.41.

According to the present disclosure, a method of manufacturing an electrode laminate and a method of manufacturing an all-solid-state battery can be provided, with which short-circuiting can be prevented while reducing the thickness of a solid electrolyte layer and with which the internal resistance of a battery can be reduced.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1A is an image showing an electrode laminate according to Comparative Example 1 when seen from an oblique direction;

FIG. 1B is an image showing an electrode laminate according to Example 2 when seen from an oblique direction;

FIG. 2A is an image showing the electrode laminate according to Comparative Example 1 when seen from the top;

FIG. 2B is an image showing the electrode laminate according to Example 2 when seen from the top; and

FIG. 3 is a diagram showing internal resistance ratios (%) of all-solid-state batteries according to Examples 7 to 9 and Comparative Example 5;

FIG. 4A is a diagram schematically showing an electrode laminate in which a solid electrolyte layer is formed on an active material layer having a relatively small value for a product of a filling factor of the active material layer and a volume proportion of an active material in the active material layer; and

FIG. 4B is a diagram schematically showing an electrode laminate in which a solid electrolyte layer is formed on an active material layer having a relatively large value for a product of a filling factor of the active material layer and a volume proportion of an active material in the active material layer.

### DETAILED DESCRIPTION OF EMBODIMENTS

Hereinafter, embodiments of the disclosure will be described in detail. The disclosure is not limited to the following embodiment, and various modifications can be made within the scope of the disclosure. In the drawings, a dimensional ratio is changed for convenience of description and may be different from an actual dimensional ratio. Further, in the description of the drawings, like reference numerals represent like components, and the description thereof will not be repeated.

“A filling factor of an active material layer” refers to a value obtained by dividing the density (g/cm³) of the active material layer by the true density (g/cm³) of the active material layer. “A volume proportion of an active material in an active material layer” refers to a value obtained by dividing the true volume (cm³) of the active material in the active material layer by the true volume (cm³) of all the materials in the active material layer. “True density” refers to a value obtained by dividing the mass of a material by the true volume of the material and represents the density obtained without considering the volume of gaps generated in the material. “True volume” refers to a density value obtained only in consideration of the volume of a material without considering the volume of gaps generated in the material.

<<Electrode Laminate>>

A method of manufacturing an electrode laminate according to an embodiment of the disclosure, which includes an active material layer and a solid electrolyte layer formed on the active material layer, includes: an active material layer forming step of forming an active material layer; and a solid electrolyte layer forming step of forming a solid electrolyte layer on the active material layer by applying a solid electrolyte layer-forming slurry to the active material layer and drying the solid electrolyte layer-forming slurry.

In the process of manufacturing an electrode laminate, in particular, an electrode laminate for an all-solid-state battery, in general, a solid electrolyte layer is formed on an active material layer, for example, using a method including: disposing a solid electrolyte layer, which is prepared in another step, on an active material layer; and pressing these layers. However, in consideration of the actual manufacturing process, this method is not preferable because, for example, it has a large number of procedures and is complicated.

However, in the method of manufacturing an electrode laminate according to the embodiment, an active material layer can be formed on a solid electrolyte layer by directly applying a solid electrolyte layer-forming slurry to the active material layer and drying the solid electrolyte layer-forming slurry. Therefore, in the method of manufacturing an electrode laminate according to the embodiment of the disclosure, the number of procedures can be reduced and simplified compared to the method of manufacturing an electrode laminate including the pressing step.

However, from the viewpoint of improving energy density, ionic conductance, and the like as described above, it is preferable that the thickness of the solid electrolyte layer is as small as possible. In regard to this point, the present inventors found that, when the solid electrolyte layer-forming slurry is directly applied to the active material layer, a product of (i) a filling factor of the active material layer and (ii) a volume proportion of a material having the largest average particle size, for example, an active material in the active material layer may have effects on whether or not short-circuiting occurs and on a variation in internal resistance in the electrode laminate and an all-solid-state battery into which the electrode laminate is incorporated.

Typically, it is considered that, as (i) the filling factor of the active material layer decreases, a portion of the solid electrolyte layer-forming slurry is more likely to seep in the vicinity of the surface of the active material layer. However, the present inventors found that the degree to which a portion of the solid electrolyte layer-forming slurry seeps in the vicinity of the surface of the active material layer can be expressed not by only the factor (i) but the combination (product) of the factors (i) and (ii). The product of (i) and (ii) represents a filling factor obtained only in consideration of the material having the largest average particle size in the active material layer, in other words, represents a ratio of the true volume of the material having the largest average particle size to the bulk volume of the active material layer.

For example, in a case where the product is relatively small, a portion of the solid electrolyte layer-forming slurry is likely to seep in the vicinity of the surface of the active material layer, the thickness of the solid electrolyte layer varies, that is, thin and thick portions are formed in the solid electrolyte layer. As a result, short-circuiting is likely to occur, particularly, in a thin portion of the solid electrolyte layer. For example, in a case where the product is relatively large, a portion of the solid electrolyte layer-forming slurry is not likely to seep in the vicinity of the surface of the active material layer, the interface resistance between the solid electrolyte layer and the active material layer increases. As a result, the internal resistance of a battery, in particular, an all-solid-state battery is likely to increase.

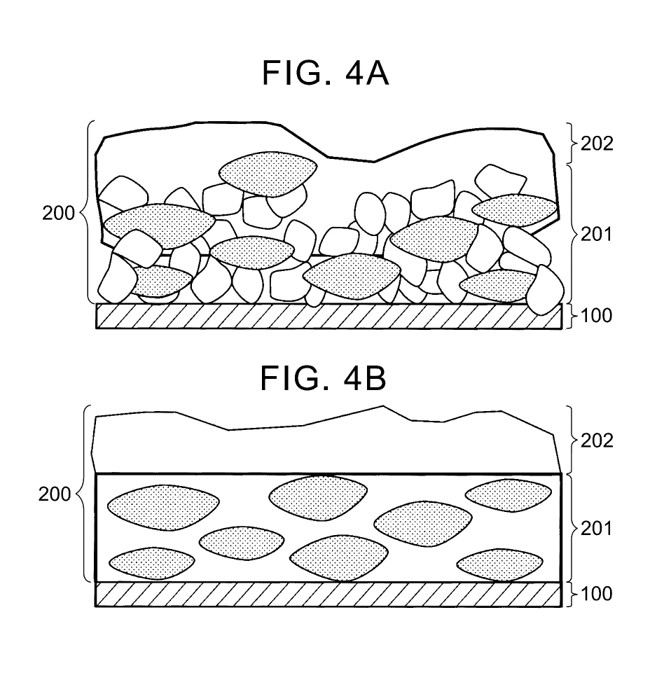

FIG. 4A is a diagram schematically showing an electrode laminate in which a solid electrolyte layer is formed on an active material layer having a relatively small value for a product of a filling factor of the active material layer and a volume proportion of an active material in the active material layer. FIG. 4B is a diagram schematically showing an electrode laminate in which a solid electrolyte layer is formed on an active material layer having a relatively large value for a product of a filling factor of the active material layer and a volume proportion of an active material in the active material layer.

In each of FIGS. 4A and 4B, an active material layer 201 and a solid electrolyte layer 202 are laminated on a current collector layer 100 in this order, and an electrode laminate 200 includes the active material layer 201 and the solid electrolyte layer 202.

In FIG. 4A, the thickness of the solid electrolyte layer 202 formed on the active material layer 201 varies, that is, thin and thick portions are formed in the solid electrolyte layer 202. As a result, short-circuiting is likely to occur, particularly, in a thin portion of the solid electrolyte layer 202. In FIG. 4B, the interface resistance between the active material layer 201 and the solid electrolyte layer 202 formed on the active material layer 201 increases. As a result, the internal resistance of a battery is likely to increase.

Accordingly, the present inventors performed a thorough investigation on a product of (i) a filling factor of the active material layer and (ii) a volume proportion of a material having the largest average particle size, for example, an active material in the active material layer, thereby conceiving the following means for solving the problems.

<Product of Filling Factor of Active Material Layer and Volume Proportion of Active Material>

That is, in the method of manufacturing an electrode laminate according to the embodiment, a product of a filling factor of the active material layer and a volume proportion of an active material in the active material layer is 0.33 to 0.41.

According to this configuration, by adjusting the product of the filling factor of the active material layer and the volume proportion of the material having the largest average particle size, for example, the active material in the active material layer to be in the above-described range, an electrode laminate can be manufactured, with which short-circuiting can be prevented while reducing the thickness of a solid electrolyte layer and with which the internal resistance of a battery can be reduced.

In general, as the area of the active material layer increases, the thickness of the solid electrolyte layer is more likely to vary, that is, thin and thick portions are more likely to be present in the solid electrolyte layer. As a result, short-circuiting is more likely to occur. However, in the method of manufacturing an electrode laminate according to the embodiment, even in a case where an active material layer having a large area is used, short-circuiting can be prevented while reducing the thickness of a solid electrolyte layer. Accordingly, the method according to the embodiment is particularly suitable in a case where a solid electrolyte layer is formed on an active material layer having a large area.

The product of the filling factor of the active material layer and the volume proportion of the material having the largest average particle size, for example, the active material in the active material layer is preferably 0.33, or more, 0.34 or more, or 0.35 or more from the viewpoint of preventing short-circuiting, and is preferably 0.41 or less or 0.40 or less from the viewpoint of reducing the interface resistance between the active material layer and the solid electrolyte layer.

The thickness of the solid electrolyte layer-forming slurry layer and/or the thickness of the solid electrolyte layer are not particularly limited and is preferably 5 μm or more, 10 μm or more, or 15 μm or more and/or is preferably 50 μm or less, 30 μm or less, or 20 μm or less from the viewpoint of improving energy density, ionic conductance, and the like of a battery into which the electrode laminate manufactured using the method according to the embodiment is incorporated.

<Active Material Layer Forming Step>

The active material layer forming step is not particularly limited, and a well-known step can be adopted. Examples of the active material layer forming step include a step of applying an active material layer-forming slurry to a current collector formed of a metal to form an active material layer-forming slurry layer thereon and drying and/or firing the active material layer-limning slurry layer.

A method of applying the slurry is not particularly limited and a well-known coating method can be adopted. Examples of the coating method include methods using a blade coater, a gravure coater, a dipping coater, a reverse coater, a roll knife coater, a wire bar coater, a slot die coater, an air knife coater, a curtain coater, an extrusion coater, and a combination thereof.

Further, a time and a temperature during the drying and/or firing of the slurry are not particularly limited. For example, the slurry is dried and/or fired at a temperature of normal temperature to 500° C. for 30 minutes to 24 hours.

(Pressing Step)

The active material layer forming step may include a pressing step. The pressing step is not particularly limited, and a well-known pressing step may be adopted. In the pressing step, the filling factor of the active material layer can be controlled.

<Solid Electrolyte Layer Forming Step>

The solid electrolyte layer forming step is not particularly limited, and a well-known step can be adopted. Examples of the solid electrolyte layer forming step include a step of applying a solid electrolyte layer-forming slurry to the active material layer to form a solid electrolyte layer-forming slurry layer thereon and drying and/or firing the solid electrolyte layer-forming slurry layer. A method of applying the slurry, and a temperature and a time during drying and firing can refer to the description regarding the active material layer forming step.

<Active Material Layer and Active Material Layer-Forming Slurry Layer>

The active material layer is formed by drying and/or firing the active material layer-forming slurry layer. Further, the active material layer-forming slurry layer is formed by applying the active material layer-forming slurry. Examples of the active material layer-forming slurry include a positive electrode active material layer-forming slurry and a negative electrode active material layer-forming slurry.

(Positive Electrode Active Material Layer-Forming Slurry)

The positive electrode active material layer-forming slurry includes a positive electrode active material and optionally further includes a conductive additive, a binder, a solid electrolyte, and a dispersion medium.

As the positive electrode active material, a metal oxide containing at least one transition metal selected from lithium, manganese, cobalt, nickel, and titanium can be used. Examples of the positive electrode active material include lithium cobalt oxide, lithium nickel oxide, lithium nickel manganese cobalt oxide, and a combination thereof

The form of the positive electrode active material may be particles. The average particle size of the positive electrode active material particles is not particularly limited, and is, for example, 1 μm or more, 3 μm or more, 5 μm or more, or 10 μm or more and is, for example, 100 μm or less, 50 μm or less, 30 μm or less, or 20 μm or less. The average particle size of the positive electrode active material particles is preferably in a range of 1 μm to 50 μm, more preferably in a range of 1 μm to 20 μm, still more preferably in a range of 1 μm to 10 μm, even still more preferably in a range of 1 μm to 6 μm, and yet even still more preferably in a range of 4 μm to 5 μm.

For example, in the embodiment, a ratio D₁/D₂ of the average particle size D₁ of the solid electrolyte particles to the average particle size D₂ of the active material particles is preferably 1.00 or lower, 0.80 or lower, 0.63 or lower, 0.60 or lower, 0.40 or lower, or 0.25 or lower, more preferably 0.21 or lower, and still more preferably 0.01 to 0.20.

In the embodiment, the particle size of a particle can be obtained by directly measuring the projected area equivalent circle diameter of the particle based on an image obtained by observation using a scanning electron microscope (SEM) or the like. The average particle size can be obtained by measuring the particle sizes of ten or more particles and obtaining the average thereof.

Further, the positive electrode active material optionally further includes a buffer film. The buffer film can prevent production of a metal sulfide having a high electric resistance generated by a chemical reaction between the positive electrode active material and the solid electrolyte. Alternatively, the buffer film prevents the growth of a lithium ion depletion layer (space charge layer). As a result, the output of an all-solid-state battery can be improved.

The buffer film may have an anionic species which exhibits electron insulating properties and ion conductivity and has a strong cation trapping force. Examples of the buffer film include a solid oxide electrolyte such as lithium niobate (LiNbO₃). However, the buffer film is not limited to the example.

Examples of the conductive additive include: a carbon material such as vapor grown carbon fiber (VGCF), carbon black, Ketjen black, carbon nanotube, or carbon nanofiber; a metal material; and a combination thereof.

The binder is not particularly limited and examples thereof include a polymer resin such as polyvinylidene fluoride (PVDF), butadiene rubber (BR), styrene-butadiene nibber (SBR), styrene-ethylene-butylene-styrene block copolymer (SEBS), or carboxymethyl cellulose (CMC) and a combination thereof.

The solid electrolyte is not particularly limited, and a raw material which can be used as a solid electrolyte can be used. Examples of the solid electrolyte include: an amorphous sulfide solid electrolyte such as Li₂S—P₂S₅; an amorphous oxide solid electrolyte such as Li₂O—B₂O₃—P₂O₅; a crystal oxide solid electrolyte such as Li_{1.3}Al_{0.3}Ti_{0.7}(PO₄)₃ or Li_{1+x+y}AₓTi₂₋ₓSi_{y}P_{3-y}O₁₂ (A represents Al or Ga; 0≦x≦0.4, 0<y≦0.6); and a combination thereof. An amorphous sulfide solid electrolyte is preferably used from the viewpoint of obtaining satisfactory lithium ion conductivity.

The form of the solid electrolyte may be powder. For example, the particle size of the solid electrolyte particles is preferably in a range of 0.1 μm to 20 μm, more preferably in a range of 0.2 μm to 10 μm, still more preferably in a range of 0.3 μm to 6 μm, and even still more preferably in a range of 0.5 μm to 3 μm.

The dispersion medium is not particularly limited as long as it is stably present in the active material layer. Examples of the dispersion medium include a nonpolar solvent, a polar solvent, and a combination thereof. Examples of the nonpolar solvent include heptane, xylene, toluene, and a combination thereof. Examples of the polar solvent include a tertiary amine solvent, an ether solvent, a thiol solvent, an ester solvent, and a combination thereof. Examples of the polar solvent include a tertiary amine solvent such as triethyl amine; an ether solvent such as cyclopentyl methyl ether; a thiol solvent such as ethane mercaptan; an ester solvent such as butyl butyrate; and a combination thereof.

(Negative Electrode Active Material Layer-Forming Slurry)

The negative electrode active material layer-forming slurry includes a negative electrode active material and optionally further includes a conductive additive, a binder, a solid electrolyte, and a dispersion medium.

The negative electrode active material is not particularly limited as long as it can store and release, for example, metal ions such as lithium ions. Examples of the negative electrode active material include: a metal such as Li, Sn, Si, or In; an alloy of lithium and titanium, magnesium, or aluminum; a carbon material such as hard carbon, soft carbon, or graphite; and a combination thereof.

The form of the negative electrode active material may be particles. The average particle size of the negative electrode active material particles is not particularly limited and may be in a range of 2 μm to 10 μm.

A relationship between the average particle size of the negative electrode active material particles and the average particle size of the solid electrolyte particles can refer to the description regarding the positive electrode active material layer-forming slurry.

The conductive additive, the binder, the solid electrolyte, and the dispersion medium of the negative electrode active material layer-forming slurry can refer to the description regarding the positive electrode active material layer-forming slurry.

<Solid Electrolyte Layer and Solid Electrolyte Layer-Forming Shiny>

The solid electrolyte layer is included in the electrode laminate including the active material layer and the current collector layer. The solid electrolyte layer is formed by drying and/or firing the solid electrolyte layer-forming slurry layer. Further, the solid electrolyte layer-forming slurry layer is formed by applying the solid electrolyte layer-forming slurry.

The solid electrolyte layer-forming slurry includes a solid electrolyte and optionally further includes a binder and a dispersion medium. The solid electrolyte and the optional components including the binder and the dispersion medium of the solid electrolyte layer-forming slurry can refer to the description regarding the positive electrode active material layer-forming slurry.

<<Method of Manufacturing all-Solid-State Battery>>

A method of manufacturing an all-solid-state battery according to the embodiment including a positive electrode current collector layer, a positive electrode active material layer, a solid electrolyte layer, a negative electrode active material layer, and a negative electrode current collector layer in this order includes: an active material layer forming step of forming a positive electrode active material layer and a negative electrode active material layer on a positive electrode current collector layer and a negative electrode current collector layer, respectively; a solid electrolyte layer forming step of forming a solid electrolyte layer on at least one of the positive electrode active material layer or the negative electrode active material layer by applying a solid electrolyte layer-forming slurry to the active material layer and drying the solid electrolyte layer-forming slurry; and a joining step of laminating the positive electrode current collector layer, the positive electrode active material layer, the solid electrolyte layer, the negative electrode active material layer, and the negative electrode current collector layer in this order and joining these layers to each other such that the solid electrolyte layer is interposed between the positive electrode active material layer and the negative electrode active material layer.

In the method of manufacturing an all-solid-state battery according to the embodiment, an active material layer is formed on a solid electrolyte layer by directly applying a solid electrolyte layer-forming slurry to the active material layer and drying the solid electrolyte layer-forming slurry. Therefore, in the method of manufacturing an all-solid-state battery according to the embodiment, the number of procedures can be reduced and simplified compared to a method of manufacturing an all-solid-state battery in the related art in which a solid electrolyte layer is formed first and then is laminated on an active material layer.

<Product of Filling Factor of Active Material Layer and Volume Proportion of Active Material>

Further, in the method of manufacturing an all-solid-state battery according to the embodiment, a product of a filling factor of the active material layer and a volume proportion of an active material in the active material layer is 0.33 to 0.41.

According to this configuration, by adjusting the product of the filling factor of the active material layer and the volume proportion of the material having the largest average particle size, for example, the active material in the active material layer to be in the above-described range, an all-solid-state battery can be manufactured, in which short-circuiting can be prevented while reducing the thickness of a solid electrolyte layer and in which the internal resistance can be reduced.

<Joining Step>

In the joining step, the positive electrode current collector layer, the positive electrode active material layer, the solid electrolyte layer, the negative electrode active material layer, and the negative electrode current collector layer are laminated in this order and then are pressed. The pressure, temperature, and time during pressing are not particularly limited. For example, the layers are pressed at a temperature of normal temperature to 300° C. under a pressure of 0 MPa to 1000 MPa for 1 minute to 24 hours. As a result, the filling factor of each of the layers constituting the all-solid-state battery is increased, the contact area between adjacent layers and the contact area of solid-solid interfaces between particles is increased, and thus the ion conduction resistance can be reduced.

<Current Collector Layer>

Examples of the current collector layer include a positive electrode current collector layer and a negative electrode current collector layer. The positive electrode current collector layer or the negative electrode current collector layer can be formed of various metals such as silver, copper, gold, aluminum, nickel, iron, stainless steel, or titanium, or alloys thereof without any particular limitation. From the viewpoint of chemical stability, the positive electrode current collector layer may be formed of aluminum, and the negative electrode current collector layer may be formed of copper.

In the method of manufacturing an all-solid-state battery according to the embodiment, layer forming steps, a method of applying the slurry, a time and a temperature during the drying and firing of the slurry layer, a pressure during pressing, and raw materials of the respective layers and the respective slurries can refer to the description regarding the method of manufacturing an electrode laminate.

The disclosure will be described in more detail with reference to the following Examples. However, it is needless to say that the scope of the disclosure is not limited to these Examples.

### Comparative Example 1

### Preparation of Negative Electrode Active Material Layer

A negative electrode mixture as a raw material of a negative electrode active material layer was put into a polypropylene (PP) case. The negative electrode mixture was stirred for 30 seconds using an ultrasonic disperser (Model name: UH-50, manufactured by SMT Corporation) and was shaken for 30 minutes using a shaker (Model name: TTM-1, manufactured by Sibata Scientific Technology Ltd.). As a result, a negative electrode active material layer-forming slurry was prepared.

With a blade method using an applicator, this negative electrode active material layer-forming slurry was applied to a Cu foil as a negative electrode current collector layer to form a negative electrode active material layer-forming slurry layer thereon. The negative electrode active material layer-forming slurry layer was dried on a hot plate at 100° C. for 30 minutes. As a result, a negative electrode active material layer formed on the Cu foil was obtained. The configuration of the negative electrode mixture was as follows:
Natural graphite-based carbon as a negative electrode active material (manufactured by Mitsubishi Chemical Corporation, average particle size: 10 μm);
Heptane as a dispersion medium;
Butyl butyrate (5 mass %) containing a PVDF binder as a binder; and
Li₂S—P₂S₅ glass ceramic containing LiI as a solid electrolyte (average particle size: 0.8 μm).

The volume proportion of the negative electrode active material in the negative electrode active material layer was 53.8%.

<Adjustment of Filling Factor of Negative Electrode Active Material Layer>

In the negative electrode active material layer according to Comparative Example 1, the filling factor thereof was not adjusted using a roll press or the like.

### Examples 1 and 2 and Comparative Examples 2 to 3

Negative electrode active material layers according to Examples 1 and 2 and Comparative Examples 2 and 3 were prepared using the same preparation method as that of the negative electrode active material layer according to Comparative Example 1, except that they were roll-pressed to adjust the filling factors thereof. In the negative electrode active material layers according to Comparative Example 2, Examples 1 and 2, and Comparative Example 3, the pressure during the pressing was 13 kN/cm, the feed rate was 0.5 m/min, and the gaps between rolls were 450 μm, 400 μm, 300 μm, and 100 μm, respectively.

### Example 3

### Preparation of Positive Electrode Active Material Layer

A positive electrode mixture as a raw material of a positive electrode active material layer was put into a polypropylene (PP) case. The positive electrode mixture was stirred for 30 seconds using an ultrasonic disperser (Model name: UH-50, manufactured by SMT Corporation), was shaken for 3 minutes using a shaker (Model name: TTM-1, manufactured by Sibata Scientific Technology Ltd.), and was further stirred using the ultrasonic disperser for 30 seconds. As a result, a positive electrode active material layer-forming slurry was prepared.

With a blade method using an applicator, this positive electrode active material layer-forming slung was applied to an Al foil as a positive electrode current collector layer to form a positive electrode active material layer-forming slurry layer thereon. The positive electrode active material layer-forming slurry layer was dried on a hot plate at 100° C. for 30 minutes. As a result, a positive electrode active material layer formed on the Al foil was obtained. The configuration of the positive electrode mixture was as follows:
LiNi_{1/3}Co_{1/3}Mn_{1/3}O₂ (average particle size: 4 μm) as a positive electrode active material;
Heptane as a dispersion medium;
VGCF as a conductive additive;
Butyl butyrate solution (5 mass %) containing a PVDF binder as a binder; and
Li₂S—P₂S₅ glass ceramic containing LiI as a solid electrolyte (average particle size: 0.8 μm).

The volume proportion of the positive electrode active material in the positive electrode active material layer was 65.6%.

<Adjustment of Filling Factor of Positive Electrode Active Material Layer>

In the positive electrode active material layer according to Example 3, the filling factor thereof was not adjusted using a roll press or the like.

### Examples 4 to 6 and Comparative Example 4

Positive electrode active material layers according to Examples 4 to 6 and Comparative Example 4 were prepared using the same preparation method as that of the positive electrode active material layer according to Example 3, except that they were roll-pressed to adjust the filling factors thereof. In the positive electrode active material layers according to Examples 4 to 6 and Comparative Example 4, the pressure during the pressing was 13 kN/cm, the feed rate was 0.5 m/min, and the gaps between rolls were 375 μm, 350 μm, 300 μm, and 100 μm, respectively.

<<Evaluation>>

The filling factor of the active material layer and the volume proportion of the active material were evaluated, an electrode laminate was evaluated by visual inspection, and the short-circuiting and internal resistance of an all-solid-state battery into which the electrode laminate was incorporated were evaluated.

<Product of Filling Factor of Active Material Layer and Volume Proportion of Active Material>

The filling factors of the negative electrode active material layers according to Examples 1 and 2 and Comparative Examples 1 to 3 and the positive electrode active material layer according to Examples 3 to 6 and Comparative Example 4, which were obtained after application and drying or after application, drying, and roll-pressing, and the volume proportions of the active materials therein were evaluated.

The volume proportion of the material having the largest average particle size, that is, the active material in the active material layer was calculated by adding the true densities of the plural materials constituting the active material layer, for example, the active material, the solid electrolyte, the binder, and the conductive additive and dividing the true density of the active material by the added value.

The filling factor of the active material layer was calculated by dividing the density (g/cm³) of the active material layer by the true density (g/cm³) of the active material layer. The density (g/cm³) of the active material layer was calculated based on: the mass of the negative electrode active material layer according to each of the Examples 1 and 2 and Comparative Examples 1 to 3 when measured after punched using a punching tool having a diameter of 13.00 mm; and the thickness in a laminating direction and the area in a plane direction of the punched negative electrode active material layer when measured after restricted under a pressure of 15 MPa. In addition, the density (g/cm³) of the positive electrode active material layer according to each of Examples 3 to 6 and Comparative Example 4 was calculated using the same method as that of the negative electrode active material layer, except that the positive electrode active material layer was punched using a punching tool having a diameter of 11.28 mm.

Further, the true density of the active material layer was calculated based on the true densities of the materials constituting the active material layer, which were measured using the Archimedes method, and the conventional mass values thereof in the active material layer. The product of the filling factor of the active material layer and the volume proportion of the active material for Comparative Examples 1-4 and Examples 1-6 are summarized in Table 1.

TABLE 1

| | | | Gap | Filling | Volume | Filling Factor of |
|---|---|---|---|---|---|---|
| | | | between | Factor of | Proportion of | Layer × Volume |
| | | | Rolls | Layer | Active Material | Proportion of Active |
| | Kind of Layer | State of Layer | (μm) | (%) | (%) | Material |
| Comparative | Negative | Only Application | — | 60 | 53.8 | 0.32 |
| Example 1 | Electrode | and Drying | | | | |
| | Active Material | | | | | |
| | Layer | | | | | |
| Comparative | Negative | Application and | 450 | 61 | 53.8 | 0.32 |
| Example 2 | Electrode | Drying + Roll | | | | |
| | Active Material | Pressing | | | | |
| | Layer | | | | | |
| Example 1 | Negative | Application and | 400 | 64 | 53.8 | 0.34 |
| | Electrode | Drying + Roll | | | | |
| | Active Material | Pressing | | | | |
| | Layer | | | | | |
| Example 2 | Negative | Application and | 300 | 77 | 53.8 | 0.41 |
| | Electrode | Drying + Roll | | | | |
| | Active Material | Pressing | | | | |
| | Layer | | | | | |
| Comparative | Negative | Application and | 100 | 92 | 53.8 | 0.49 |
| Example 3 | Electrode | Drying + Roll | | | | |
| | Active Material | Pressing | | | | |
| | Layer | | | | | |
| Example 3 | Positive | Only Application | — | 51 | 65.6 | 0.33 |
| | Electrode | and Drying | | | | |
| | Active Material | | | | | |
| | Layer | | | | | |
| Example 4 | Positive | Application and | 375 | 52 | 65.6 | 0.34 |
| | Electrode | Drying + Roll | | | | |
| | Active Material | Pressing | | | | |
| | Layer | | | | | |
| Example 5 | Positive | Application and | 350 | 53 | 65.6 | 0.34 |
| | Electrode | Drying + Roll | | | | |
| | Active Material | Pressing | | | | |
| | Layer | | | | | |
| Example 6 | Positive | Application and | 300 | 61 | 65.6 | 0.40 |
| | Electrode | Drying + Roll | | | | |
| | Active Material | Pressing | | | | |
| | Layer | | | | | |
| Comparative | Positive | Application and | 100 | 77 | 65.6 | 0.50 |
| Example 4 | Electrode | Drying + Roll | | | | |
| | Active Material | Pressing | | | | |
| | Layer | | | | | |

(Preparation of Solid Electrolyte Layer-Forming Slurry)

An electrolyte mixture as a raw material of a solid electrolyte layer was put into a polypropylene (PP) case. The electrolyte mixture was stirred for 30 seconds using an ultrasonic disperser (Model name: UH-50, manufactured by SMT Corporation) and was shaken for 30 seconds using a shaker (Model name: TTM-1, manufactured by Sibata Scientific Technology Ltd.). As a result, a solid electrolyte layer-forming slurry was prepared. The configuration of the electrolyte mixture was as follows:
Heptane as a dispersion medium;
Heptane (5 mass %) containing a BR binder as a binder; and
Li₂S—P₂S₅ glass ceramic containing LiI as a solid electrolyte (average particle size: 2.5 μm).

The ratio D₁/D₂ of the average particle size D₁ of the solid electrolyte particles to the average particle size D₂ of the positive electrode active material particles was 0.20, and the ratio D₁/D₂ of the average particle size D₁ of the solid electrolyte particles to the average particle size D₂ of the negative electrode active material particles was 0.08.

(Preparation of Electrode Laminate)

The solid electrolyte layer-forming slurry was applied to each of the negative electrode active material layers according to Examples 1 and 2 and Comparative Examples 1 to 3, whose filling factors were adjusted, using a die coater to form a solid electrolyte layer-forming slurry layer thereon. The solid electrolyte layer-forming slurry layer was dried on a hot plate at 100° C. for 30 minutes. As a result, a negative electrode-side electrode laminate including the negative electrode current collector layer, the negative electrode active material layer, and the solid electrolyte layer was obtained.

A positive electrode-side electrode laminate was prepared using the same preparation method of the negative electrode-side electrode laminate, except that each of the positive electrode active material layers according to Examples 3 to 6 and Comparative Example 4, whose filling factors were adjusted, was used instead of the negative electrode active material layer.

The positive electrode-side electrode laminate and the negative electrode-side electrode laminate were roll-pressed. The pressure during pressing was 13 kN/cm, the feed rate was 0.5 m/min, and the gap between rolls was 100 μm.

(Evaluation of Electrode Laminate by Visual Inspection)

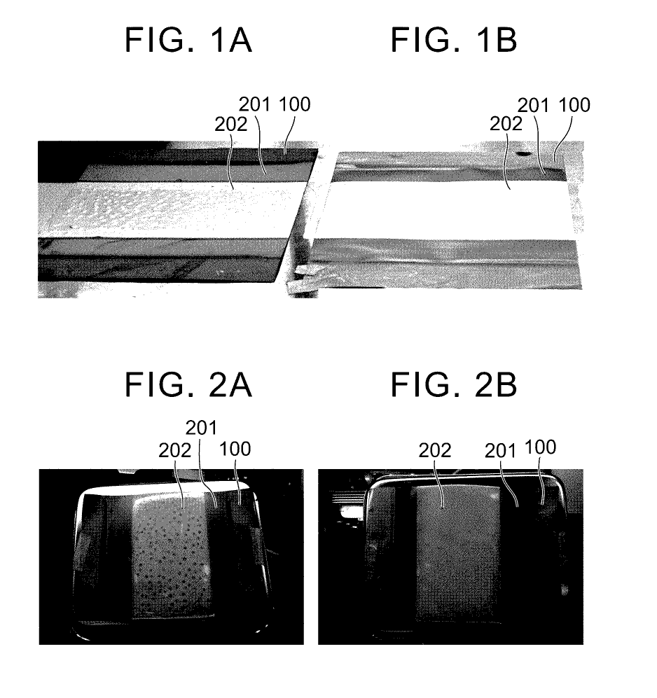

FIGS. 1A and 2A are images showing the electrode laminate according to Comparative Example 1 when seen from an oblique direction and from the top. It can be seen from these images that convex and concave portions were present in the surface of the solid electrolyte layer 202. The reason for this is presumed to be that, since the product of the filling factor of the negative electrode active material layer and the volume proportion of the active material was 0.32, a portion of the solid electrolyte layer-forming slurry seeped easily in the vicinity of the surface of the active material layer, and thus the thickness of the solid electrolyte layer varied, that is, thin and thick portions were formed in the solid electrolyte layer.

FIGS. 1B and 2B are images showing the electrode laminate according to Example 2 when seen from an oblique direction and from the top. It can be seen from these images that substantially no convex and concave portions were present on the surface of the solid electrolyte layer 202 compared to the electrode laminate according to Comparative Example 1. The reason for this is presumed to be that, since the product of the filling factor of the negative electrode active material layer and the volume proportion of the active material was 0.41, a portion of the solid electrolyte layer-forming slurry did not substantially seep in the vicinity of the surface of the active material layer, and thus the thickness of the solid electrolyte layer did not vary, that is, thin and thick portions were not formed in the solid electrolyte layer.

<Evaluation of Short-Circuiting and Internal Resistance of all-Solid-State Battery into which Electrode Laminate were Incorporated>

(Preparation of all-Solid-State Battery)

The positive electrode-side electrode laminate was punched using a punching tool having a diameter of 11.28 mm, and the negative electrode-side electrode laminate was punched using a punching tool having a diameter of 13.00 mm. The positive electrode-side electrode laminate and the negative electrode-side electrode laminate were laminated such that surfaces thereof on the solid electrolyte layer side face each other, and then were pressed. During pressing, the pressure was 200 MPa, the temperature was 130° C., and the time was 1 minute. As a result, the layers were joined to each other, and an all-solid-state battery was prepared. A relationship between the positive electrode-side electrode laminate and the negative electrode-side electrode laminate in the all-solid-state battery is shown in Table 2 below.

(Measurement of Internal Resistance of all-Solid-State Battery)

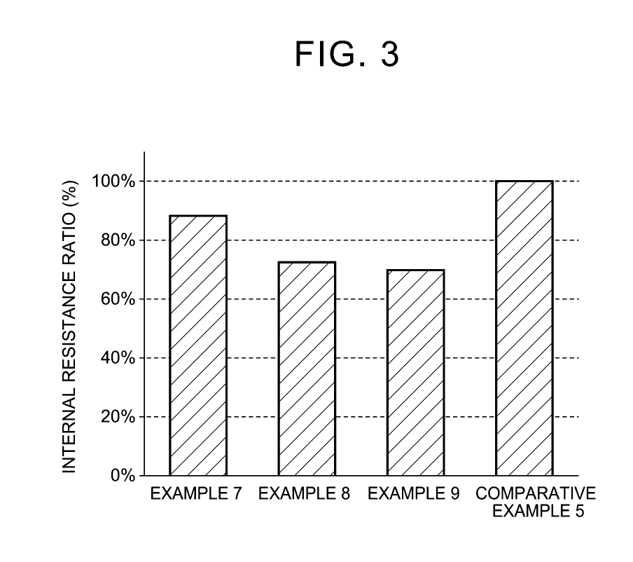

The internal resistance of the all-solid-state battery was measured. The results are shown in Table 2 below and FIG. 3 (a drawing showing internal resistance ratios (%) of the all-solid-state batteries according to Examples 7 to 9 and Comparative Example 5). Measurement conditions of the internal resistance are as follows:

(i) Constant current-constant voltage charging (end hour rate: 1/100 C rate) was performed until the voltage reached 4.55 V at 3 hour rate (1/3 C rate);

(ii) Constant-current discharging was performed until the voltage reached 3 V;

(iii) Constant current-constant voltage charging was performed until the voltage reached 3.88 V; and

(iv) Constant-current discharging was performed at 7 C rate for 5 seconds, and the battery resistance was calculated based on a voltage drop and a current value during the discharging.

“C rate” is an index in which “1.00 C” represents a constant current value at which an all-solid-state battery having a nominal capacity is completely discharged in 1 hour. For example, “0.20 C” represents a constant current value at which the all-solid-state battery is completely discharged in 5 hours, and “0.10 C” represents a constant current value at which the all-solid-state battery is completely discharged in 10 hours.

TABLE 2

| | Positive | Filling Factor of | Negative | Filling Factor of | |
|---|---|---|---|---|---|
| | Electrode-Side | Layer × Volume | Electrode-Side | Layer × Volume | Internal |
| All-Solid-State | Electrode | Proportion of | Electrode | Proportion of | Resistance Ratio |
| Battery | Laminate | Active Material | Laminate | Active Material | (%) |
| Example 7 | Example 6 | 0.40 | Example 2 | 0.41 | 88 |
| Example 8 | Example 4 | 0.34 | Example 1 | 0.34 | 72 |
| Example 9 | Example 3 | 0.33 | Example 1 | 0.34 | 70 |
| Comparative | Comparative | 0.50 | Comparative | 0.49 | 100 |
| Example 5 | Example 4 | | Example 3 | | |
| Comparative | Example 3 | 0.33 | Comparative | 0.32 | Short-Circuiting |
| Example 6 | | | Example 1 | | |

Table 2 shows, by percentage, the ratios of the internal resistances of the all-solid-state batteries according to Examples 7 to 9 to the internal resistance of the all-solid-state battery Comparative Example 5 which is 100%.

In the all-solid-state battery according to Comparative Example 6, the internal resistance was not able to be measured due to short-circuiting. The reason for this is presumed to be that, since the product of the filling factor of the negative electrode active material layer and the volume proportion of the active material in the negative electrode-side electrode laminate (Comparative Example 1) was 0.32, the thickness of the negative electrode-side solid electrolyte layer varied, that is, thin and thick portions were formed in the negative electrode-side solid electrolyte layer; and as a result, short-circuiting easily occurred, particularly, in a thin portion of the solid electrolyte layer.

In the all-solid-state battery according to Comparative Example 6, the positive electrode-side electrode laminate according to Example 3 was used. However, it should be noted that this electrode laminate itself had no problems. That is, the following is presumed; in the all-solid-state battery according to Comparative Example 6, short-circuiting occurred due to the negative electrode-side electrode laminate according to Comparative Example 1; and as long as short-circuiting does not occur in the negative electrode-side electrode laminate, by using the positive electrode-side electrode laminate according to Example 3, an all-solid-state battery can be realized in which short-circuiting is prevented while reducing the thickness of the solid electrolyte layer and in which the internal resistance is reduced.

In addition, it can be seen from Table 2 and FIG. 3 that the internal resistance ratio of the all-solid-state battery according to Comparative Example 5 was higher than those of the all-solid-state batteries according to Examples 7 to 9. The reason for this is presumed to be that, since the products of the filling factors of the active material layers and the volume proportions of the active materials in the positive electrode-side electrode laminate (Comparative Example 4) and the negative electrode-side electrode laminate (Comparative Example 3) were relatively large, the interface resistance between the solid electrolyte layer and the active material layer increased; and as a result, the internal resistance of the all-solid-state battery increased.

In regard to this point, it can be seen that, in each of the all-solid-state batteries according to Examples 7 to 9, the product of the filling factor of the active material layer and the volume proportion of the active material in each of the electrode laminates was 0.33 to 0.41; and as a result, the all-solid-state battery was able to be realized in which short-circuiting was prevented while reducing the thickness of the solid electrolyte layer and in which the internal resistance was reduced.

It can be seen that a comparison between the electrode laminates according to Comparative Example 2 and Example 6 in Table 1 that the filling factors of the active material layers were the same at 61%; however, the volume proportions of the active materials were different from each other, and the products of the filling factors of the active material layers and the volume proportions of the active materials were different from each other. It can be seen from Tables 1 and 2 that, in the electrode laminates according to Comparative Examples 1 and 2, the products of the filling factors of the active material layers and the volume proportions of the active materials were the same; and in the all-solid-state battery according to Comparative Example 6 in which the electrode laminate according to Comparative Example 1 was used, short-circuiting occurred.

It can be understood in consideration of the above-results that, in the all-solid-state batteries in which the electrode laminate according to Comparative Example 2 was used, short-circuiting is highly likely to occur; however, in the all-solid-state batteries according to Example 7 in which the electrode laminate according to Example 6 was used, the internal resistance was relatively low while preventing short-circuiting.

Accordingly, the following points can be understood: the degree to which a portion of a solid electrolyte layer-forming slurry seeps in the vicinity of an active material layer is difficult to determine based on only a filling factor of the active material layer and relates to a product of the filling factor of the active material layer and a volume proportion of an active material in the active material layer.

The embodiment of the disclosure has been described. However, those skilled in the art can understand that various modifications can be made for devices and chemicals, manufacturers and grades thereof, and the positions and dispositions of the manufacturing line.

What is claimed is:

1. A method of manufacturing an electrode laminate which includes an active material layer and a solid electrolyte layer formed on the active material layer, the method comprising:
forming the active material layer; and
forming the solid electrolyte layer on the active material layer by applying a solid electrolyte layer-forming slurry to the active material layer and drying the solid electrolyte layer-forming slurry, wherein
a product of a filling factor of the active material layer and a volume proportion of an active material in the active material layer is 0.33 to 0.41.

2. The method according to claim 1, wherein
the active material layer is pressed.

3. A method of manufacturing an all-solid-state battery which includes a positive electrode current collector layer, a positive electrode active material layer, a solid electrolyte layer, a negative electrode active material layer, and a negative electrode current collector layer in this order, the method comprising:
forming the positive electrode active material layer and the negative electrode active material layer on the positive electrode current collector layer and the negative electrode current collector layer, respectively;
forming the solid electrolyte layer on at least one of the positive electrode active material layer or the negative electrode active material layer by applying a solid electrolyte layer-forming slurry to the at least one of the positive electrode active material layer or the negative electrode active material layer and drying the solid electrolyte layer-forming slurry; and
laminating the positive electrode current collector layer, the positive electrode active material layer, the solid electrolyte layer, the negative electrode active material layer, and the negative electrode current collector layer in this order and joining the positive electrode current collector layer, the positive electrode active material layer, the solid electrolyte layer, the negative electrode active material layer, and the negative electrode current collector layer to each other such that the solid electrolyte layer is interposed between the positive electrode active material layer and the negative electrode active material layer, wherein
a product of a filling factor of the positive electrode active material layer and the negative electrode active material layer and a volume proportion of an active material in the positive electrode active material layer and the negative electrode active material layer, respectively, is 0.33 to 0.41.
